(19) United States
(12) Patent Application Publication
(10) Pub. No.: US 2008/0296960 A1
(43) Pub. Date: Dec. 4, 2008

(54) TIRE TRACTION ADAPTOR AND METHOD

(76) Inventor: Stephane GRATON, Ste-Marguerite (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/757,473

(22) Filed: Jun. 4, 2007

(51) Int. Cl. B60B 15/00

(52) U.S. Cl. 301/41.1

(57) ABSTRACT

A device for providing traction between a wheel and a road/ground comprises a main panel having a top surface with a panel pattern for the main panel to be used as a mat for a vehicle with the panel pattern exposed. The panel pattern cooperating with a tread of a wheel to provide an engagement with the wheel. Spikes project from a bottom surface of the main panel. The spikes are concealed under the main panel when the main panel is used as a mat, the spikes gripping into the road/ground when the tire is against the main panel. An extension projects from an edge of the main panel and is lodged under a seat when the device is used as a mat, the extension having a top surface with an extension pattern cooperating with the tread of the wheel to engage the main panel with the wheel.

### BACKGROUND OF THE INVENTION

1. Field of the Invention

The present invention generally relates to adaptors positionable on tires to increase traction between the tire and the ground, and to a method for installing the adaptors with respect to the tires.

2. Background Art

During colder periods of the year, drivers frequently experience a reduction of traction between their vehicle and the ground/road. The reduction of traction may be caused by various factors: ice build-ups on the road, snow accumulations on the road, slippery terrain, the presence of fluids such as water, oil and other vehicle leaks, presence of snow or ice in the tire treads.

Accordingly, various solutions have been developed in order to lessen the reduction of traction due to some of these factors. For instance, some types of tires are specifically designed for winter conditions, or for all four seasons. Such tires have deeper treads, sharper tread edges, and/or increased ratio of tread grooving to road contact surface.

In some harsh conditions, winter or four-season tires are not enough and additional traction is required. For instance, after a snowfall, or when a vehicle is idling with its tires on an icy surface, adaptors are used to provide this additional traction. Such adaptors are positioned between the drive tires and the ground. These adaptors grip the ground while engaging with the tires to give the vehicle the necessary momentum to move on the icy surface.

One type of these adaptors takes the form of a metal track. The metal track has teeth that grip onto ice or snow, and is typically formed of segments interconnected by revolute joints, such that the metal track adapts to the shape of the road and of the tire.

An inconvenience known to these metal tracks is that they are often propelled by the tires after having served their purpose, as the tires rotate at high revolutions as a result of a lack of traction. The metal tracks hence propelled are a hazard (especially when used on the back wheels of rear-wheel drives or all-wheel drives), and may cause damage to nearby vehicles, or harm pedestrians standing close to the car.

Another inconvenience with such tracks is that they are typically kept in the trunks of vehicles. Therefore, following a snowfall, at which time these tracks are often required, the trunk must be opened in order to get the tracks. This may result in snow getting into the trunk of the vehicle, whereby unwanted humidity reaches the trunk.

Another type of these adaptors is a chain system that covers the wheels. The chains grip the icy/snowy surface to provide the required traction to enable the vehicle to gain some momentum. After use, the chains must often be removed, and their removal, as well as their installation, are lengthy procedures.

### SUMMARY OF INVENTION

It is an aim of the present invention to provide a novel tire traction adaptor.

It is a further aim of the present invention to provide a tire traction adaptor that substantially overcomes the disadvantages of the prior art.

It is a still further aim of the present invention to provide a novel method for installing a tire traction adaptor.

Therefore, in accordance with the present invention, there is provided a device for providing traction between a wheel and a road/ground, comprising: a main panel having a top surface with a panel pattern for the main panel to be used as a mat for a vehicle with the panel pattern exposed, the panel pattern cooperating with a tread of a wheel to provide an engagement with the wheel; spikes projecting from a bottom surface of the main panel, the spikes being concealed under the main panel when the main panel is used as a mat, the spikes gripping into the road/ground when the tire is against the main panel; and an extension projecting from an edge of the main panel and lodged under a seat when the device is used as a mat, the extension having a top surface with an extension pattern cooperating with the tread of the wheel to engage the main panel with the wheel.

Further in accordance with the present invention, there is provided a method for using a traction device to add traction to a vehicle, comprising the steps of: removing the traction device from a floor of a vehicle where the traction device is used as a mat; positioning an extension of the traction device against a wheel, with a main panel having downwardly-facing spikes oriented in a direction where the vehicle is headed; and actuating the wheel such that the cooperation between the extension and main panel causes the main panel to contact the wheel, whereby the spikes provide additional traction.

Still further in accordance with the present invention, there is provided a device for providing traction between a wheel and a road/ground, comprising: an elongated panel having a first and a second surface; gripping means on the first surface of the elongated panel; and complementary connectors at opposed ends of the elongated panel, the complementary connectors being releasably connectable to one another, so as to install the elongated panel on a periphery of the wheel with the first surface being exposed radially, whereby the gripping means cooperate with the road/ground to create traction between the wheel and the road/ground.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a tire traction adaptor in accordance with a first embodiment of the present invention;

FIG. 2 is a bottom plan view of the tire traction adaptor of FIG. 1;

FIG. 3 is a side elevation view of the tire traction adaptor of FIG. 1;

FIG. 4A is a schematic side view illustrating the tire traction adaptor of FIG. 1, as positioned with respect to a tire for a subsequent use;

FIG. 4B is a schematic side view illustrating the tire traction adaptor of FIG. 1, as positioned with respect to the tire when in use;

FIG. 5 is a top plan view of a tire traction adaptor in accordance with a second embodiment of the present invention;

FIG. 6 is a bottom plan view of the tire traction adaptor of FIG. 5;

FIG. 7A is a schematic side view illustrating the tire traction adaptor of FIG. 5, as positioned with respect to a tire for a subsequent use;

FIG. 7B is a schematic side view illustrating the tire traction adaptor of FIG. 5, as positioned for subsequently being installed onto the tire;

FIG. 7C is a schematic side view illustrating the tire traction adaptor of FIG. 5, as installed on the tire; and

FIG. 8 is an enlarged view of connected ends of the tire traction adaptor of FIG. 5.

### DESCRIPTION OF THE PREFERRED EMBODIMENTS

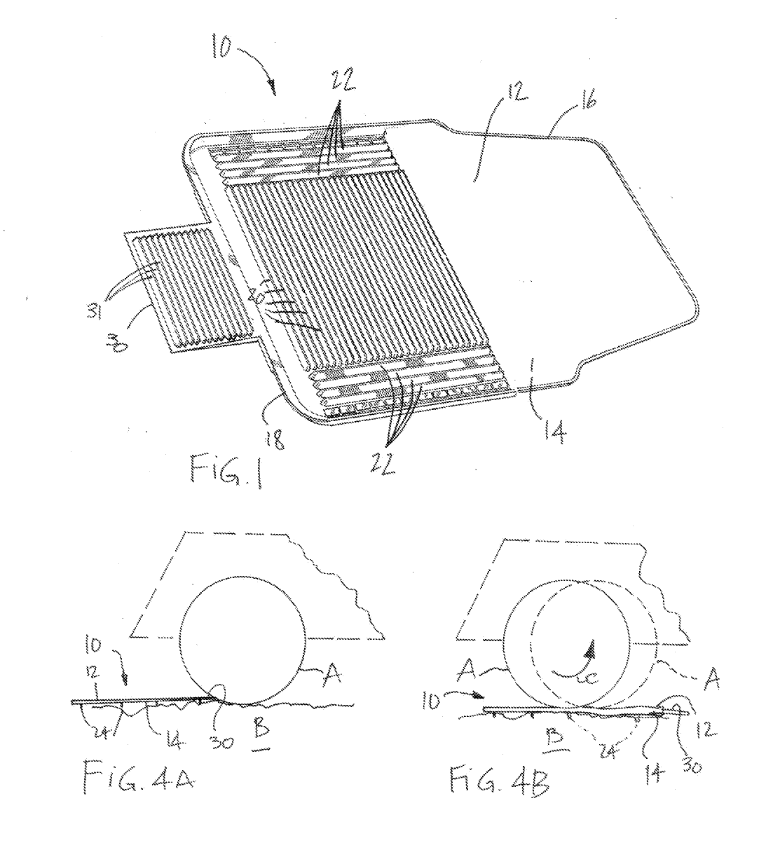

Referring to the drawings, and more particularly to FIG. 1, a tire traction adaptor in accordance with a first embodiment has a car mat 10. The car mat 10 has a panel having a top surface 12 and an undersurface 14.

The car mat 10 has a generally rectangular shape, but has a tapering portion 16 that projects from a rectangular portion 18. The tapering portion 16 is typically positioned under the pedals of the vehicle when the car mat 10 is positioned on the driver's side. The rectangular portion 18 has a series of transverse slats 20, and longitudinal slats 22, that all project upwardly from the top surface 12.

The slats 20 and 22 are optionally provided in the car mat 10 as a pattern for the main panel of the mat 10, so as to prevent trouser bottoms of a driver of the vehicle from dipping into the humidity present at the feet of the driver. For instance, this humidity is a result of melted snow, water and the like that is inadvertently brought into the vehicle on the footwear of the driver. This humidity, in the liquid phase, gathers between the slats 20 and/or 22, while the trouser bottoms are generally prevented from contacting this liquid by the slats 20 and/or 22.

The car mat 10 is to be used as a traction adaptor, by being positioned between the wheel and the ground/road. Accordingly, referring concurrently to FIGS. 2 and 3, spikes 24 project downwardly from the undersurface 14 of the car mat 10. The spikes 24 are provided in accordance with a first embodiment so as to grip the road when the car mat 10 is used as traction adaptor.

The spikes 24 are made of a rigid material that will grip the ice/snow or the road surfacing (e.g., asphalt, soil, or the like), such that the wheel will roll onto the top of the car mat 10 to gain sufficient momentum to move forward or backward.

In order to ensure that the wheel cooperates with the car mat 10, an extension ramp 30 projects from the rear end of the car mat 10. The extension ramp tapers vertically toward its free end, and supports a plurality of slats 31 on its top surface, the slats 31 forming an extension pattern. The slats 31 are illustrated as being similar in size to the slats 20, but may be smaller or larger as well. Moreover, it is considered to space the slats 31 apart, in view of an interconnection between the slats 31 and the tread of a tire.

The extension ramp 30 is made of a rubbery material, and is typically molded integrally with the car mat 10. It is pointed out that the extension ramp 30 is lodged under that car seat, and is therefore not visible when installed in the car.

Referring to FIG. 2, the ramp 30 is shown having spikes 24 on its bottom surface. The spikes 24 are of a rigid material such as a metal, and will grip the road when the car mat 10 is used as a traction aid. Suitable dimensions for the ramp extension 30 are a length of 7 inches by a width of 6 inches. However, it is considered to provide the ramp extension 30 in other dimensions. Moreover, it is not required that the ramp extension 30 be tapered vertically.

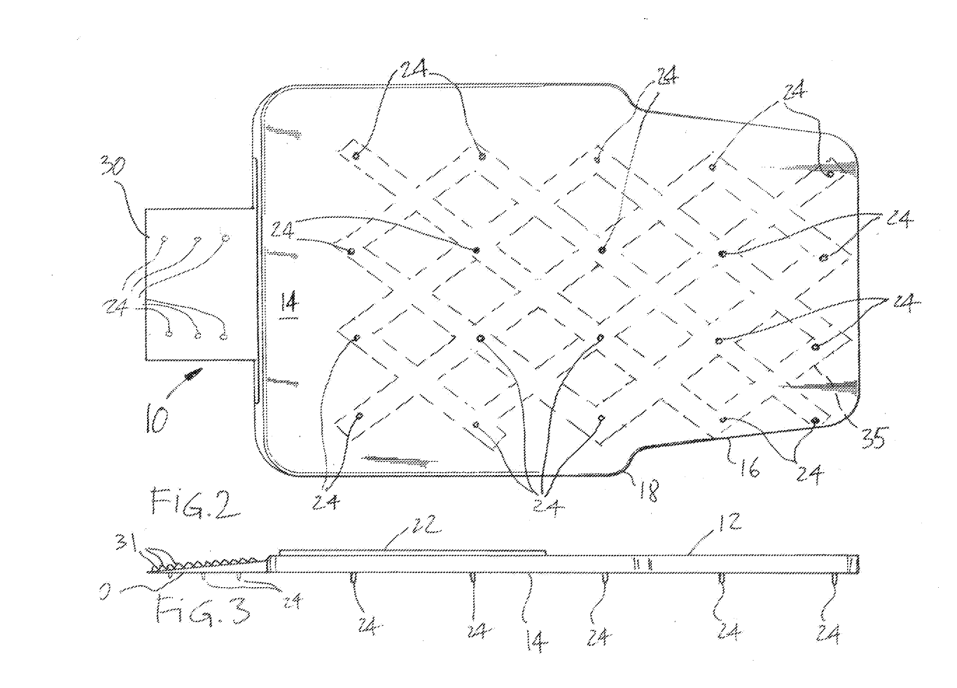

Referring to FIGS. 4A and 4B, the car mat 10 is shown during its use as a traction aid. More specifically, as shown in FIG. 4A, the car mat 10 is positioned just in front of a tire A, with the undersurface 14 against the ground B, and the ramp extension 30 in contact with the tire A (with the slats 31 in contact with the tire A). Thereafter, the rotation of the tire A, in a direction indicated as C in FIG. 4B, catches the extension 30 and causes the car mat 10 to grip the ground B, while the tire A moves onto the top surface 14. The vehicle therefore gains momentum, that will enable it to move forward. It is pointed out that there is illustrated in FIG. 4B the previous position of the tire A, shown in dashed lines.

Vehicles generally have carpeting on their floors. Preferably, the spikes 24 are sized so as to squeeze between carpet fibers, with the undersurface 14 of the car mat 10 lying on top of the carpet fibers. Accordingly, the cat mat 10 of the present invention lies generally flat on the carpeting of the car, such that the car mat 10 resembles typical car mats.

Considering that the car mat 10 will be subjected to various stresses (e.g., traction of the wheel on the top surface 12 while being retained on the road/ground by the spikes 24, exposure to various liquids at cold temperatures), the car mat 10 should be constructed so as withstand these conditions over several uses. The car mat 10 is for instance made of a plastic, a rubber, or has a carpeted top face with a plasticized base material, but has a structure element that will enable the car mat 10 to withstand these conditions.

As seen in FIG. 2, the car mat 10 is optionally provided with a metallic structure 35 covered by a plastic body of the car mat 10. The spikes 24 may form a single piece with the metallic structure 35, as illustrated in FIG. 1. Accordingly, the car mat 10 illustrated in FIGS. 1 to 3 may thus be injection-molded, with the metallic structure 35 first being inserted into the injection mold.

Alternatively, the car mat 10 may consist of an integral piece in which spikes 24 are formed. The spikes 24 may take various shapes, such as inverted pyramids, inverted cones, granulated surfacing, in accordance with the surfacing they will engage.

The car mat 10 of the first embodiment is advantageous in that it is in the driver's cabin, and not in the trunk. The fact that it serves both as a car mat and as a traction aid increases its appeal to consumers. Although not required for the first embodiment, the slats 20 increase the traction between the extension 30 and the tire A.

Referring to FIGS. 5 and 6, a tire traction adaptor in accordance with a second embodiment of the present invention is generally shown at 50. The tire traction adaptor 50 has a band 52 (i.e., elongated panel) having a top surface 54 and an undersurface 56. The top surface 54 has a pattern thereon that cooperates with a tread of a tire. The undersurface 56 has spikes 58 projecting downwardly therefrom. The spikes 58 will grip the road/ground. The spikes 58 may take various shapes, such as small cylinders, inverted pyramids or cones, etc.

The tire traction adaptor 50 has a first end 60 and a second end 62, which are provided with complementary connectors as is described below. The first end 60 has a receptacle 64, with a pair of holes 66 lateral to the receptacle 64. The holes 66 emerge out of a side of the band 52.

The second end 62 has a connector 68 projecting therefrom. A pair of fingers 70 are laterally positioned with respect to the connector 68. The fingers 70 are spring-loaded, such that they may be pressed inwardly into the connector 68.

Referring to FIG. 8, the first end 60 and the second end 62 are shown interconnected. More specifically, the connector 68 is received in the receptacle 64, such that the undersurface 56 from both ends forms a continuous smooth surface. The fingers 70 are received in the holes 66, and emerge out therefrom. As they are spring-loaded, the fingers 70 are simply depressed inwardly to enable the connection between the first end 60 and the second end 62. The first end 60 and the second end 62 may be separated from one another by pressing the fingers 70 inwardly.

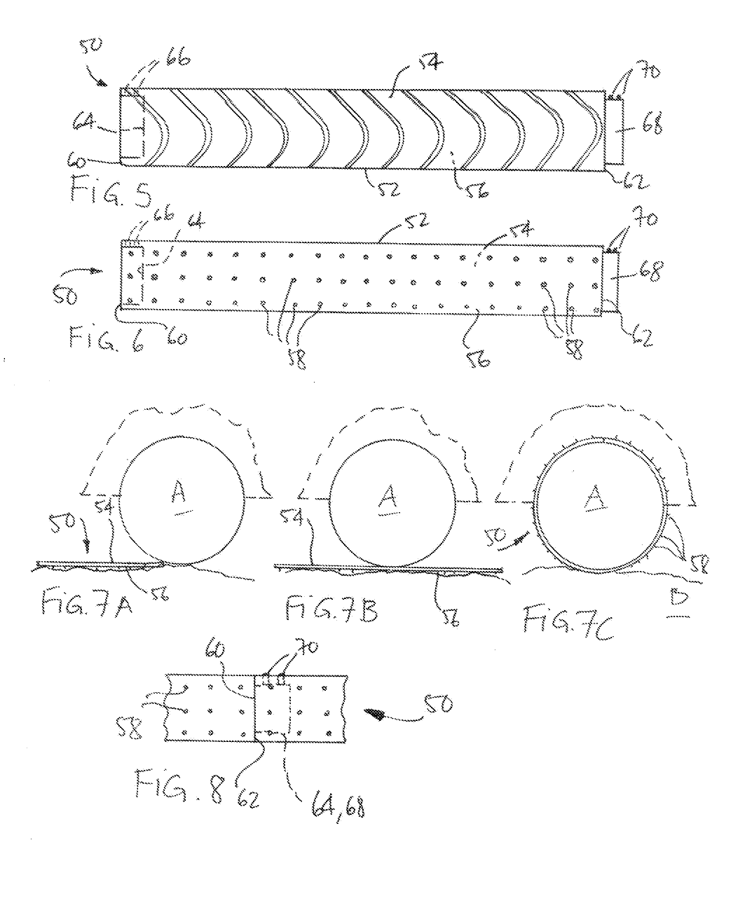

Referring to FIG. 7A, the tire traction adaptor 50 is positioned in front of the tire A prior to being used, with the spikes 58 facing downwardly, against the ground B. Thereafter, the vehicle moves forward, assisted by the traction provided by the tire traction adaptor 50, whereby the tire A moves onto the tire tractor adaptor 50.

Once the tire A is on the tire traction adaptor 50, as illustrated in FIG. 7B, the tire traction adaptor 50 may be strapped onto the tire A, as shown in FIG. 7C. The ends 60 and 62 are connected to one another as described previously. In the configuration illustrated in FIG. 7C, the spikes 58 project radially from the tire A, whereas the pattern on the top surface 54 (FIG. 5) of the tire traction adaptor 50 generally prevents slippage between the adaptor 50 and the tire A.

The tire traction adaptor 50 is advantageously used in instances where traction is required for small distances. For instance, traction may be required for more than an initial momentum push, like to drive on an unplowed road segment (e.g., a long driveway leading to a cottage) In such instances, the tire traction adaptor 50 stays on the tire to provide continuous traction. It is considered to also provide the tire traction adaptor 50 in a semi-permanent configuration (for instance, using a threaded fastener to interconnect the ends 60 and 62), such that the tire traction adaptor 50 could be used for longer time spans.

The tire traction adaptor 50 is typically made of a plastic/rubber material. It is also contemplated to make the tire traction adaptor 50 of recycled tires. The tire traction adaptor 50 may have some resilience, so as to adapt to a range of tire sizes. Alternatively, the tire traction adaptor 50 may come in various sizes, specific to some tires.

It is within the ambit of the present invention to cover any obvious modifications of the embodiments described herein, provided such modifications fall within the scope of the appended claims.

1. A device for providing traction between a wheel and a road/ground, comprising:
a main panel having a top surface with a panel pattern for the main panel to be used as a mat for a vehicle with the panel pattern exposed, the panel pattern cooperating with a tread of a wheel to provide an engagement with the wheel;
spikes projecting from a bottom surface of the main panel, the spikes being concealed under the main panel when the main panel is used as a mat, the spikes gripping into the road/ground when the tire is against the main panel; and
an extension projecting from an edge of the main panel and lodged under a seat when the device is used as a mat, the extension having a top surface with an extension pattern cooperating with the tread of the wheel to engage the main panel with the wheel.

2. The device according to claim 1, wherein at least two of said spikes are interconnected by a structure.

3. The device according to claim 2, wherein the structure interconnecting said two spikes is a metallic structure integrally molded into the main panel.

4. The device according to claim 1, wherein the extension is ramp-shaped, with the extension tapering away from the main panel.

5. The device according to claim 1, wherein the extension pattern has elongated protuberances transversely positioned with respect to a longitudinal dimension of the device.

6. The device according to claim 1, wherein the panel pattern includes channels accumulating liquids while preventing trouser bottoms to contact the liquids when the device is used as a mat.

7. The device according to claim 1, wherein spikes are provided on a bottom surface of the extension.

8. A method for using a traction device to add traction to a vehicle, comprising the steps of:
removing the traction device from a floor of a vehicle where the traction device is used as a mat;
positioning an extension of the traction device against a wheel, with a main panel having downwardly-facing spikes oriented in a direction where the vehicle is headed; and
actuating the wheel such that the cooperation between the extension and main panel causes the main panel to contact the wheel, whereby the spikes provide additional traction.

9. The method according to claim 8, further comprising the steps of:
recuperating the traction device after its use to add traction;
positioning the traction device on the floor of the vehicle with the spikes oriented toward the floor; and
positioning the extension of the traction device under a seat of the vehicle.

10. A device for providing traction between a wheel and a road/ground, comprising:
an elongated panel having a first and a second surface;
gripping means on the first surface of the elongated panel; and
complementary connectors at opposed ends of the elongated panel, the complementary connectors being releasably connectable to one another, so as to install the elongated panel on a periphery of the wheel with the first surface being exposed radially, whereby the gripping means cooperate with the road/ground to create traction between the wheel and the road/ground.
